(19) United States
(12) Patent Application Publication
(10) Pub. No.: US 2010/0053418 A1
(43) Pub. Date: Mar. 4, 2010

(54) IMAGING APPARATUS AND METHOD

(75) Inventor: Fuminori Irie, Miyagi (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: FUJIFILM Corporation, Tokyo (JP)

(21) Appl. No.: 12/546,655

(22) Filed: Aug. 24, 2009

(30) Foreign Application Priority Data
Aug. 27, 2008 (JP) 2008-218588

(51) Int. Cl. H04N 5/232

(52) U.S. Cl. 348/345; 348/E05.045

(57) ABSTRACT

An imaging apparatus includes a movable focus lens, and the apparatus includes an imaging unit which, when a first instruction for starting setting of an in-focus state for still-picture imaging is given during motion-picture imaging for displaying a through image, performs first still-picture imaging while maintaining an in-focus state in the motion-picture imaging for displaying a through image.

### CROSS-REFERENCE TO RELATED APPLICATIONS

This application claims the benefit of Japanese Patent Application JP 2008-218588, filed Aug. 27, 2008, the entire content of which is hereby incorporated by reference, the same as if set forth at length.

### FIELD OF THE INVENTION

The present invention relates to an imaging apparatus including a movable focus lens, and an imaging method which is performed by the imaging apparatus.

### BACKGROUND OF THE INVENTION

Usually, an imaging apparatus such as a digital camera or a digital video camera is provided with a lens system for imaging an object image on an imaging element. The lens system includes: a zoom lens configured by a plurality of lens groups; and a focus lens for focusing an object image to be taken.

When an image of an object is to be taken, the focal length of the lens system is changed by driving the zoom lens so that the range of the imaging angle (field angle) can be set to a desired value, and a focusing control is automatically performed. In the focusing control, the position (in-focus position) of the focus lens where a state (in-focus state) in which focusing is performed in a specific range of the object image to be taken is searched (AF search), and the focus lens is moved to the in-focus position. The function of automatically performing the focusing control is called the AF (Auto Focus) function.

In such an imaging apparatus, it is usual that, when a still-picture imaging mode is set, for example, motion-picture imaging for displaying a through image is started, and a through image is displayed a displaying section. The motion-picture imaging for displaying a through image has two modes: a pan focus mode in which the motion-picture imaging is performed while the focus lens is fixed to a predetermined position so as to attain a state (pan focus) where focusing is performed on an object image in a range of from about 1 m to infinity with peaking at a position separated by about 2 m from the imaging apparatus; and a continuous AF mode where the AF function is continuously executed and the motion-picture imaging is performed while updating the in-focus state. JP-A-2002-90823 discloses a camera which is switchable between an automatic focus mode where the imaging is performed while the focusing is controlled by the AF function, and a fixed focus mode where the imaging is performed while the focus lens is fixed.

In a conventional imaging apparatus, when the still-picture imaging mode is set, the motion-picture imaging for displaying a through image is started in the pan focus mode or the continuous AF mode, and, after the timing when the release button is half depressed, the AF function is performed to set the in-focus state for the motion-picture imaging. After the setting of the in-focus state, a full depression of the release button is enabled. When the release button is fully depressed, an operation of performing the still-picture imaging in the set in-focus state is conducted.

In the operation, however, a time period for setting the in-focus state by the AF function must elapse from the timing when the user who intends to perform the still-picture imaging depresses the release button, to that when the still-picture imaging is actually enabled, and there is a possibility that the user misses a photo opportunity.

As a method of preventing a photo opportunity from being missed, for example, known are a method in which, after the in-focus state is set by the AF function, object images in a period from a start of a first release to that of a second release are continuously are taken and stored (JP-A-2001-257976 and JP-A-2002-84442), and that in which, in the case where first imaging is conducted in the AF mode and second imaging is to be conducted before elapse of a predetermined time period after the first imaging, the second imaging is conducted without performing the AF function (JP-A-2006-98589). In all the methods, however, a time period required for setting the in-focus state by the AF function must elapse from the timing when the user intends to perform the imaging, and that when the first imaging is actually enabled, and hence the possibility that the user misses a photo opportunity remains.

### SUMMARY OF THE INVENTION

The invention has been conducted in view of the above-described circumstances. It is an object of the invention to provide an imaging apparatus and method in which the possibility that the user misses a photo opportunity can be reduced as far as possible.

The imaging apparatus of the invention is imaging apparatus including a movable focus lens, wherein the apparatus includes an imaging unit which, when a first instruction for starting setting of an in-focus state for still-picture imaging is given during motion-picture imaging for displaying a through image, performs first still-picture imaging while maintaining an in-focus state in the motion-picture imaging for displaying a through image.

According to the configuration, when the first instruction is given, imaging is performed while maintaining the in-focus state in the motion-picture imaging for displaying a through image. As compared with the conventional configuration where the in-focus state is again set in response to the first instruction and the still-picture imaging is then performed, therefore, the time period required to elapse before a start of the still-picture imaging can be shortened. As a result, imaging can be performed without missing a photo opportunity.

In the imaging apparatus of the invention, the apparatus further includes an in-focus state setting unit which, after the first still-picture imaging is ended, starts the setting of the in-focus state for still-picture imaging, and, when a second instruction for performing still-picture imaging is given after the first instruction, the imaging unit performs second still-picture imaging in the in-focus state which is set by the in-focus state setting unit.

In the case where the in-focus state in the motion-picture imaging for displaying a through image is the pan focus, and the in-focus state set by the in-focus state setting unit is an in-focus state in which focusing is performed on a main object intended by the user, according to the configuration, the second still-picture imaging can be performed in the optimum in-focus state which is different from that of the first still-picture imaging. In the second still-picture imaging, although a certain time period elapses from the timing when the first instruction is given, to that when the first instruction is performed, imaging which is correspondingly higher in quality can be performed.

In this way, during the motion-picture imaging for displaying a through image, the user determines the imaging angle and continuously issues the first and second instructions, whereby the first still-picture imaging in which preference is given to the imaging speed, and the second still-picture imaging in which preference is given to the image quality can be performed on a substantially same object. Therefore, also a high quality image in the in-focus state which is intended by the user can be obtained while preventing a photo opportunity from being missed.

In the imaging apparatus of the invention, the in-focus state setting unit automatically performs the setting of the in-focus state for still-picture imaging in accordance with an object, and makes a search range of a position of the focus lens in the in-focus state to be narrower than a movable range of the focus lens in accordance with an in-focus range based on the in-focus state in the motion-picture imaging for displaying a through image.

According to the configuration, the time period from the first instruction to the timing when the setting of the in-focus state is completed by the in-focus state setting unit can be shortened, and the performance interval between the first still-picture imaging and the second still-picture imaging can be shortened. Therefore, it is possible to prevent the image contents of the first still-picture imaging and those of the second still-picture imaging from being largely different from each other, and a high quality image which the user wants can be stored.

In the imaging apparatus of the invention, the apparatus further includes a motion detecting unit which detects motion of the apparatus, and, when the motion detecting unit detects motion between the apparatus at a timing when the first still-picture imaging is performed, and the apparatus at a timing when the second instruction is given, the apparatus performs the second still-picture imaging after the motion is offset by relatively moving an optical system of the apparatus and a solid-state image pickup element so that a same object image is taken by the first still-picture imaging and the second still-picture imaging.

According to the configuration, it is possible to prevent the image contents of the first still-picture imaging and those of the second still-picture imaging from being largely different from each other, and a high quality image which the user wants can be stored.

In the imaging apparatus of the invention, the apparatus further includes: a difference detecting unit which detects a difference between first image data obtained by the first still-picture imaging and second image data obtained by the second still-picture imaging; and a recording unit which, when there is a difference between the first image data and the second image data, records the first image data and the second image data on a recording medium which can output data to an external, and which, when there is not the difference, records only the second image data on the recording medium.

In the case where the first still-picture imaging and the second still-picture imaging are performed in the same in-focus state, when the position of the imaging apparatus is not changed or when the object is not moved, for example, two sets of substantially same image data are recorded on the recording medium, respectively. According to the configuration, when there is not a difference between the image data sets, only the second image data are recorded, and hence two sets of substantially same image data can be prevented from being recorded on a recording medium. Therefore, the capacity of a recording medium can be saved, and, after imaging, the image data can be smoothly organized.

In the imaging apparatus of the invention, the apparatus further includes: an in-focus range detecting unit which detects an in-focus range for each of first image data obtained by the first still-picture imaging and second image data obtained by the second still-picture imaging; and a recording unit which records sets of information of the in-focus ranges detected by the in-focus range detecting unit, in correspondence with the first image data and the second image data.

According to the configuration, when the sets of information of the in-focus ranges which are corresponded with the first image data and the second image data are checked, it is possible to determine which image data are obtained in the intended in-focus state, and therefore the image data can be easily selected.

In the imaging apparatus of the invention, the apparatus further includes a display controlling unit which controls a displaying unit to display an image based on the image data recorded by the recording unit, and, when images based on the first image data and the second image data are to be displayed, the display controlling unit controls the displaying unit to display also the sets of information of the in-focus ranges which are recorded respectively in correspondence with the first image data and the second image data.

According to the configuration, the image data can be easily selected in accordance with the information displayed on the displaying unit.

In the imaging apparatus of the invention, the apparatus further includes a recording unit which records image data obtained by the first still-picture imaging, on a recording medium, and the recording unit deletes the image data obtained by the first still-picture imaging, in one of cases where the first instruction is cancelled after the first still-picture imaging is ended, where the second instruction is not given within a predetermined time period after the first instruction is given, and where the apparatus is moved by a predetermined amount or more after the first instruction is given.

According to the configuration, it is possible to prevent image data which are not intended by user, from being recorded on the recording medium. Therefore, the capacity of a recording medium can be saved. A cumbersome operation of deleting image data which the user does not intend to image is not required to be performed by the user. Therefore, the ease of use is improved.

In the imaging apparatus of the invention, the imaging unit performs the first still-picture imaging in accordance with imaging conditions in which a time period required to elapse before the imaging is ended is shortest among imaging conditions that can be set in imaging in the in-focus state in the motion-picture imaging for displaying a through image.

According to the configuration, the time period elapsing before the end of the first still-picture imaging can be shortened, and hence the time period from the first instruction to the timing when the setting of the in-focus state is completed by the in-focus state setting unit can be shortened. Therefore, the performance interval between the first still-picture imaging and the second still-picture imaging can be shortened, it is possible to prevent the image contents of the first still-picture imaging and those of the second still-picture imaging from being largely different from each other, and a high quality image which the user wants can be stored.

The imaging method of the invention is an imaging method which is performed by an imaging apparatus including a movable focus lens, wherein the method includes an imaging step of, when a first instruction for starting setting of an in-focus state for still-picture imaging is given during motion-picture imaging for displaying a through image, performing first still-picture imaging while maintaining an in-focus state in the motion-picture imaging for displaying a through image.

In the imaging method of the invention, the method further includes an in-focus state setting step of, after the first still-picture imaging is ended, starting the setting of the in-focus state for still-picture imaging, and, in the imaging step, when a second instruction for performing still-picture imaging is given after the first instruction, performing second still-picture imaging in the in-focus state which is set in the in-focus state setting step.

In the imaging method of the invention, in the in-focus state setting step, the setting of the in-focus state for still-picture imaging is automatically performed in accordance with an object, and a search range of a position of the focus lens in the in-focus state is made narrower than a movable range of the focus lens in accordance with an in-focus range based on the in-focus state in the motion-picture imaging for displaying a through image.

In the imaging method of the invention, the method further includes a motion detecting step of detecting motion of the apparatus, and, in the imaging step, when motion between the apparatus at a timing when the first still-picture imaging is performed, and the apparatus at a timing when the second instruction is given is detected in the motion detecting step, the second still-picture imaging is performed after the motion is offset by relatively moving an optical system of the apparatus and a solid-state image pickup element so that a same object image is taken by the first still-picture imaging and the second still-picture imaging.

In the imaging method of the invention, the method further includes: a difference detecting step of detecting a difference between first image data obtained by the first still-picture imaging and second image data obtained by the second still-picture imaging; and a recording step of, when there is a difference between the first image data and the second image data, recording the first image data and the second image data on a recording medium which can output data to an external, and, when there is not the difference, recording only the second image data on the recording medium.

In the imaging method of the invention, the method further includes: an in-focus range detecting step of detecting an in-focus range for each of first image data obtained by the first still-picture imaging and second image data obtained by the second still-picture imaging; and a recording step of recording sets of information of the in-focus ranges detected in the in-focus range detecting step, in correspondence with the first image data and the second image data.

In the imaging method of the invention, the method further includes a display controlling step of controlling a displaying unit to display an image based on the image data recorded in the recording step, and, when images based on the first image data and the second image data are to be displayed, the display controlling step controls to display also the sets of information of the in-focus ranges which are recorded respectively in correspondence with the first image data and the second image data.

In the imaging method of the invention, the method further includes a recording step of recording image data obtained by the first still-picture imaging, on a recording medium, and the image data obtained by the first still-picture imaging are deleted in the recording step, in one of cases where the first instruction is cancelled after the first still-picture imaging is ended, where the second instruction is not given within a predetermined time period after the first instruction is given, and where the apparatus is moved by a predetermined amount or more after the first instruction is given.

In the imaging method of the invention, in the imaging step, the first still-picture imaging is performed in accordance with imaging conditions in which a time period required to elapse before the imaging is ended is shortest among imaging conditions that can be set in imaging in the in-focus state in the motion-picture imaging for displaying a through image.

According to the invention, it is possible to provide an imaging apparatus and method in which the possibility that the user misses a photo opportunity can be reduced as far as possible.

### BRIEF DESCRIPTION OF THE DRAWINGS

FIG. 1 is a diagram showing the configuration of a digital camera which is an example of the imaging apparatus illustrating a first embodiment of the invention.

FIG. 2 is a view showing an operation flow in a still-picture imaging mode of the digital camera of the first embodiment.

FIG. 3 is a diagram schematically showing the configuration of a digital camera of a second embodiment.

FIG. 4 is a view showing an operation flow in the still-picture imaging mode of the digital camera of the second embodiment.

FIG. 5 is a diagram schematically showing the configuration of a digital camera of a third embodiment.

FIG. 6 is a view showing an operation flow in the still-picture imaging mode of the digital camera of the third embodiment.

FIG. 7 is a diagram schematically showing the configuration of a digital camera of a fourth embodiment.

FIG. 8 is a view showing an operation flow in the still-picture imaging mode of the digital camera of the fourth embodiment.

FIG. 9 is a diagram schematically showing the configuration of a digital camera of a fifth embodiment.

FIG. 10 is a view showing an operation flow in the still-picture imaging mode of the digital camera of the fifth embodiment.

FIG. 11 is a diagram schematically showing the configuration of a digital camera of a sixth embodiment.

FIG. 12 is a view showing an operation flow in the still-picture imaging mode of the digital camera of the sixth embodiment.

FIG. 13 is a diagram schematically showing the configuration of a digital camera of a seventh embodiment.

FIG. 14 is a view showing an operation flow in the still-picture imaging mode of the digital camera of the seventh embodiment.

### DETAILED DESCRIPTION OF THE INVENTION

Hereinafter, embodiments of the invention will be described with reference to the accompanying drawings.

### First Embodiment

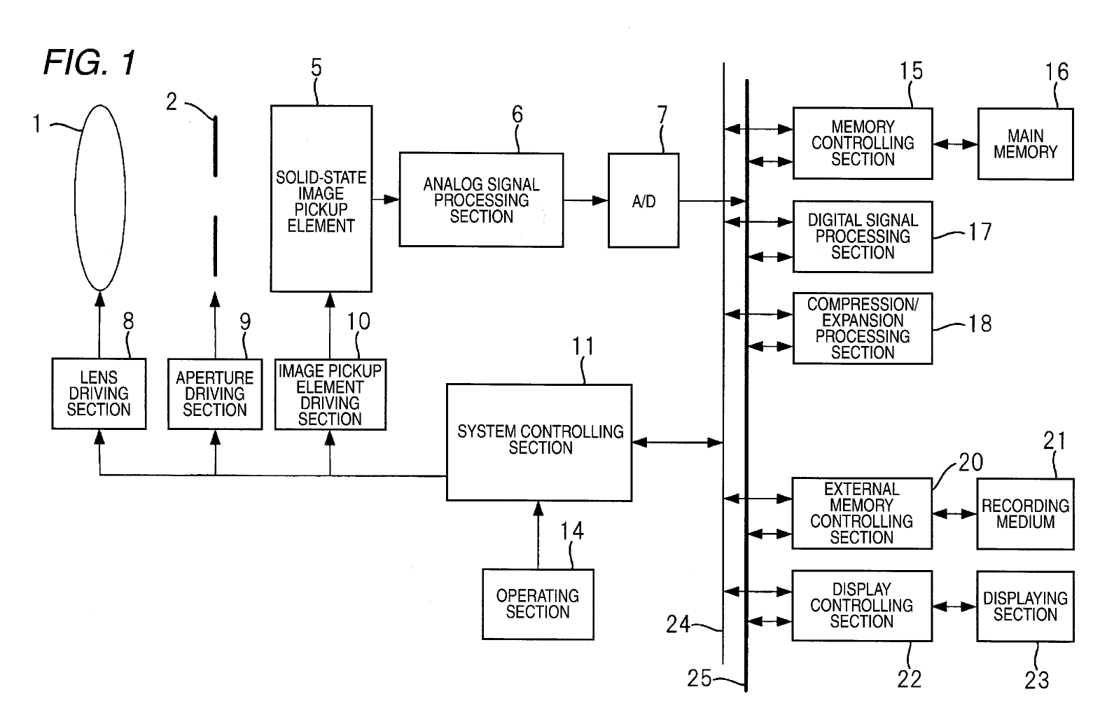

FIG. 1 is a diagram showing the configuration of a digital camera which is an example of the imaging apparatus illustrating a first embodiment of the invention.

The imaging system of the illustrated digital camera includes: an imaging lens section 1 configured by a movable focus lens, a zoom lens, and the like; a solid-state image pickup element 5 such as a CCD image sensor or a CMOS image sensor; and an aperture 2 disposed between the two components.

A system controlling section 11 which controls the whole of an electric control system of the digital camera controls a lens driving section 8 so as to adjust the focus lens included in the imaging lens section 1 to be moved to the focusing position, and perform a zoom adjustment by changing the position of the zoom lens, and also controls the opening amount of the aperture 2 through an aperture driving section 9 to adjust the exposure.

The system controlling section 11 drives the solid-state image pickup element 5 through an image pickup element driving section 10 so that an object image which is taken through the imaging lens section 1 is output as an imaging signal. An instruction signal from the user is supplied to the system controlling section 11 through an operating section 14.

The operating section 14 includes a two-stroke release button. When the release button is half depressed, a first instruction for starting setting of an in-focus state for still-picture imaging is given to the system controlling section 11, and, when the release button is fully depressed, a second instruction for performing still-picture imaging is given to the system controlling section 11.

The electric control system of the digital camera includes: an analog signal processing section 6 which is connected to the output of the solid-state image pickup element 5 for performing analog signal processing such as correlation double sampling; and an A/D converter circuit 7 which converts the imaging signal output from the analog signal processing section 6, to a digital signal. These sections are controlled by the system controlling section 11.

The electric control system of the digital camera further includes: a main memory 16 such as an SDRAM; a memory controlling section 15 which is connected to the main memory 16; a digital signal processing section 17 for performing digital signal processing such as an interpolation calculation, the gamma correction, and the RGB/YC converting process on the imaging signal output from the A/D converter circuit 7, to produce image data; a compression/expansion processing section 18 which compresses the image data produced by the digital signal processing section 17 to JPEG format data and expands compressed image data; an external memory controlling section 20 to which a detachable recording medium 21 is to be connected; and a display controlling section 22 to which a liquid crystal displaying section 23 mounted on, for example, the back face of the camera is connected. These components are connected to one another through a control bus 24 and a data bus 25, and controlled by instructions from the system controlling section 11. The main memory 16 is used as a work memory for producing image data for a through image which is to be displayed on the liquid crystal displaying section 23.

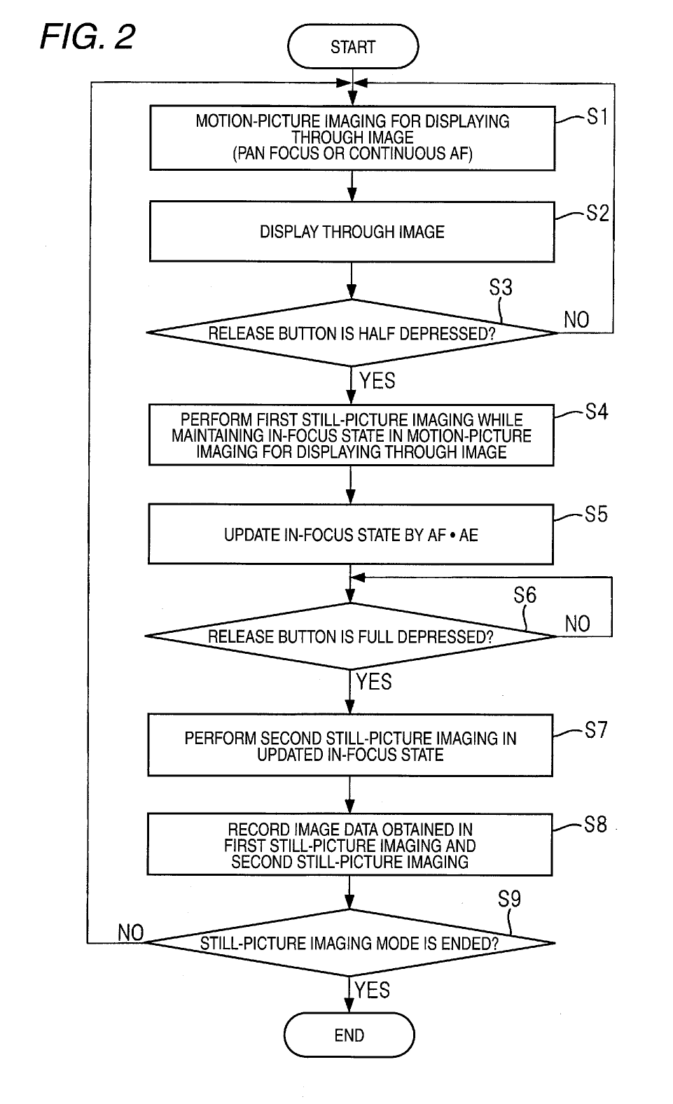

FIG. 2 is a view showing an operation flow in a still-picture imaging mode of the digital camera of the first embodiment.

When the operating section 14 is operated to set the digital camera to the still-picture imaging mode, the system controlling section 11 moves the focus lens through the lens driving section 8 to a predetermined position so that the in-focus state of the digital camera is set to the pan focus state. Then, the system controlling section 11 adjusts the opening amount of the aperture 2 through the aperture driving section 9 to a predetermined value, and drives the solid-state image pickup element 5 through the image pickup element driving section 10 to start motion-picture imaging for displaying a through image (step S1).

The in-focus state of the digital camera during the motion-picture imaging for displaying a through image is not restricted to the pan focus state. For example, the in-focus state may be continued to be periodically updated by a continuous AF function which continuously executes the AF function by using the imaging signal that is obtained during motion-picture imaging.

When the motion-picture imaging for displaying a through image is started, image data for displaying a through image are produced by the digital signal processing section 17 from the imaging signal output from the solid-state image pickup element 5, and a motion image (through image) based on the image data is displayed on the displaying section 23 through the display controlling section 22 (step S2).

If, during a period when the motion-picture imaging for displaying a through image is performed, the release button is half depressed (step S3: YES), the system controlling section 11 controls the aperture driving section 9 and the image pickup element driving section 10 to perform first still-picture imaging, while maintaining the in-focus state of the digital camera which is set at the timing when the release button is half depressed (step S4).

In the first still-picture imaging, the exposure at the timing when the release button is half depressed is applied as it is, and the imaging conditions such as the aperture 2 and the time period (exposure time) when an electronic shutter is opened are set by the system controlling section 11 so as to attain the exposure.

At the timing when the set exposure time is ended, an imaging signal corresponding to charges generated in the solid-state image pickup element 5 during the exposure time is output from the solid-state image pickup element 5, image data are produced from the imaging signal by the digital signal processing section 17, and the produced image data are temporarily stored into the main memory 16, for example, the first still-picture imaging is ended.

When the first still-picture imaging is ended, the system controlling section 11 executes the AF function to move the focus lens to the focusing position and update the in-focus state to that for still-picture imaging, and performs AE (Automatic Exposure) to set the imaging conditions (the aperture value, the exposure time, and the like) for still-picture imaging (step 5S). The release button is prevented from being fully depressed until the process of step 5S is completed.

If the release button is fully depressed after the in-focus state is updated and the imaging conditions are set (step S6: YES), the system controlling section 11 controls the aperture driving section 9 and the image pickup element driving section 10 to perform second still-picture imaging in accordance with the set imaging conditions, while maintaining the updated in-focus state (step S7).

Similarly, at the timing when the set exposure time is ended, an imaging signal corresponding to charges generated in the solid-state image pickup element 5 during the exposure time is output from the solid-state image pickup element 5, image data are produced from the imaging signal by the digital signal processing section 17, and the produced image data are temporarily stored into the main memory 16, for example, the second still-picture imaging is ended.

After the second still-picture imaging is ended, the image data obtained in the first still-picture imaging (hereinafter, referred to as the first image data), and the image data obtained in the second still-picture imaging (hereinafter, referred to as the second image data) are recorded on the recording medium 21 through the external memory controlling section 20 (step S8). The recording medium on which the image data are recorded in step S8 may be any kind of recording medium as far as the information recorded thereon can be output to the outside of the digital camera. The recording may be performed on an internal memory disposed in the digital camera, in place of the detachable recording medium 21.

After the recording is completed, if the still-picture imaging mode is to be continued (step S9: NO), the process is transferred to step S1, and, if the still-picture imaging mode is ended (step S9: YES), the operation is ended.

As described above, according to the digital camera of the embodiment, when the first instruction is issued by a half depression of the release button, the first still-picture imaging is performed while maintaining the in-focus state in the motion-picture imaging for displaying a through image. As compared with the conventional configuration where, when the first instruction is issued, the in-focus state is updated to that for the still-picture imaging and the still-picture imaging is then performed, therefore, the time period required to elapse before a start of the still-picture imaging can be shortened. As a result, imaging can be performed without missing a photo opportunity.

When, after the first still-picture imaging is ended, the release button is fully depressed to issue the second instruction, the second still-picture imaging can be performed in the in-focus state which is updated to that for still-picture imaging. In the second still-picture imaging, although a certain time period elapses from the timing when the first instruction is given, to that when the first instruction is performed, the imaging can be correspondingly conducted in a state where focusing is performed on a main object intended by the user.

In this way, during the motion-picture imaging for displaying a through image, the user determines the imaging angle and continuously issues the first and second instructions, whereby the first still-picture imaging in which preference is given to the imaging speed, and the second still-picture imaging in which preference is given to the image quality can be performed on a substantially same object. Therefore, also a high quality image in the in-focus state which is intended by the user can be obtained while preventing a photo opportunity from being missed.

### Second Embodiment

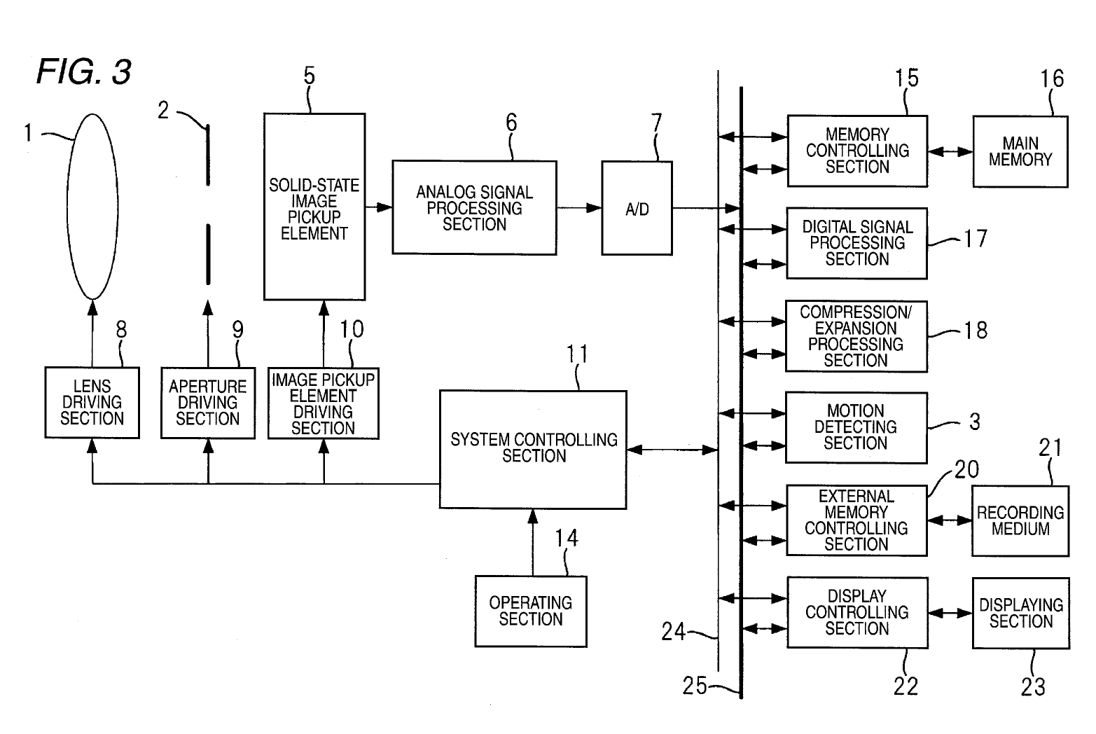

FIG. 3 is a diagram schematically showing the configuration of a digital camera of a second embodiment. In FIG. 3, similar components as those of FIG. 1 are denoted by the same reference numerals.

In the digital camera shown in FIG. 3, the imaging lens section 1 of the digital camera shown in FIG. 1 can be moved not only in the direction vertical to the light receiving face of the solid-state image pickup element 5, but also in the horizontal direction, and the lens driving section 8 controls also the horizontal movement of the imaging lens section 1. The function of the system controlling section 11 is partly different from the first embodiment. A motion detecting section 3 configured by, for example, a physical sensor which detects motion (the angular velocity, the acceleration, the inclination, and the like) of the digital camera is added to the digital camera.

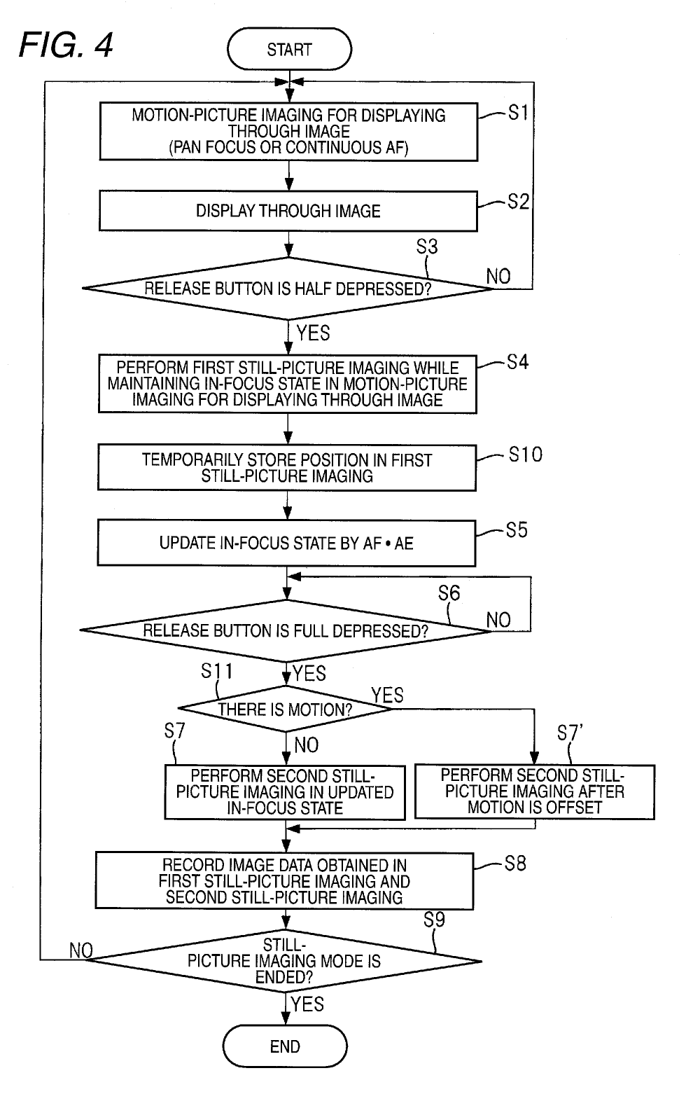

FIG. 4 is a view showing an operation flow in the still-picture imaging mode of the digital camera of the second embodiment. In FIG. 4, the same processes as those of FIG. 2 are denoted by the same reference numerals, and their description is omitted.

Simultaneously with the start of the process of step S4, the motion detecting section 3 stores the position and orientation of the digital camera at the timing when the first still-picture imaging is performed, into the memory (step S10). After step S10, step S5 is performed. When the release button is fully depressed in step S6, the motion detecting section 3 detects the position and orientation of the digital camera at the timing when the full depression is conducted, and compares them with the position and orientation of the digital camera stored in the memory, to detect whether the digital camera is moved from the timing when the first still-picture imaging is performed or not.

When the position and orientation of the digital camera at the timing when the first still-picture imaging is performed coincide with those at the timing when the release button is fully depressed, the motion detecting section 3 determines that the digital camera is not moved, and, when not coincide with each other, determines that the digital camera is moved.

If the digital camera is moved (step S11: YES), the system controlling section 11 moves the imaging lens section 1 in the direction along which the detected motion is offset, and then performs the second still-picture imaging in accordance with the in-focus state and imaging conditions which are set in step S5 (step S7′). By contrast, if the digital camera is not moved (step S11: NO), the process of step S7 is executed. After step S7 or S7′, the processes including and subsequent to step S8 are executed.

As described above, according to the digital camera of the embodiment, in the case where there is motion between the digital camera at the timing when the first still-picture imaging is performed, and that at the timing when the second instruction is given, the second still-picture imaging is performed after the imaging lens section 1 is moved so as to offset the motion. Therefore, the same object image can be taken by the first still-picture imaging and the second still-picture imaging. Consequently, it is possible to prevent the image contents of the first still-picture imaging and those of the second still-picture imaging from being largely different from each other, and a high quality image which the user wants can be stored. Even in the case where the motion of the digital camera is so excessively large that the motion cannot be corrected, a wanted image is obtained by the first still-picture imaging, and hence the worst case that a wanted image is not obtained can be prevented from occurring.

Alternatively, the imaging lens section 1 may be fixed, and the motion of the digital camera may be offset by moving the solid-state image pickup element 5, or by moving both the section and the element.

### Third Embodiment

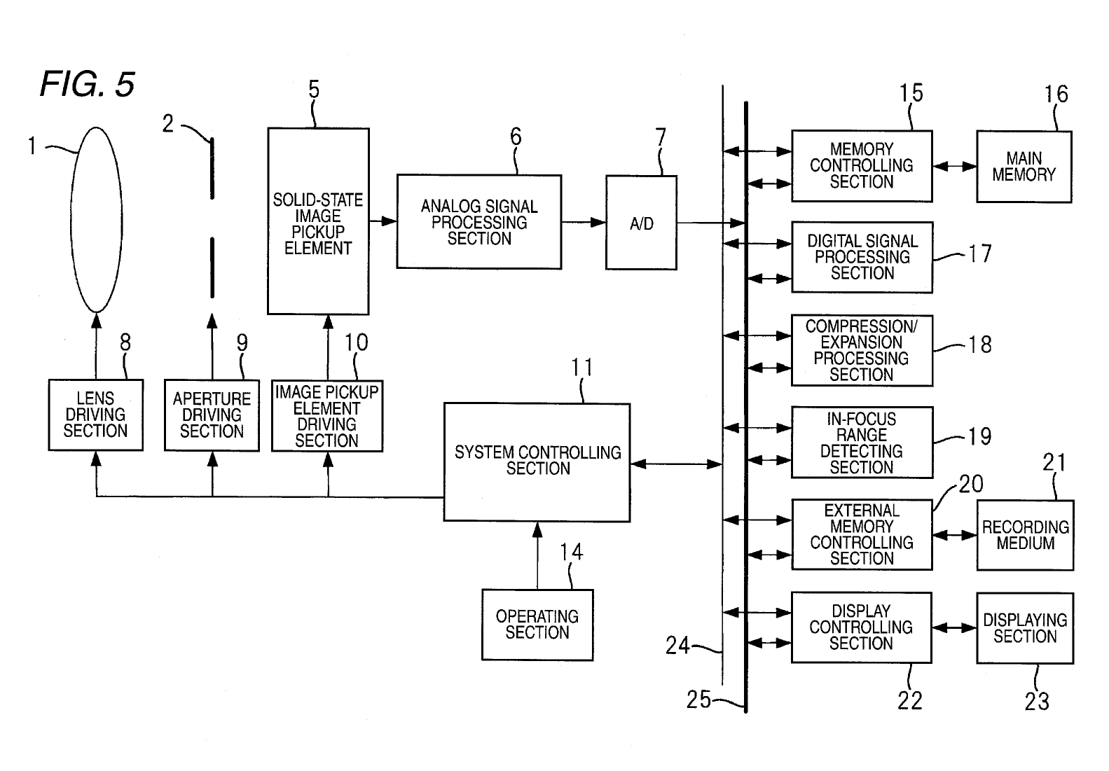

FIG. 5 is a diagram schematically showing the configuration of a digital camera of a third embodiment. In FIG. 5, similar components as those of FIG. 1 are denoted by the same reference numerals.

In the digital camera shown in FIG. 5, an in-focus range detecting section 19 is added to the digital camera shown in FIG. 1, and the function of the system controlling section 11 is partly changed.

Each time when the in-focus state is updated during the motion-picture imaging for displaying a through image, the in-focus range detecting section 19 calculates an in-focus range (a range where in-focus is regarded to be attained) in the in-focus state. When the in-focus state is set to the pan focus state, for example, the in-focus range can be calculated from the position of the focus lens.

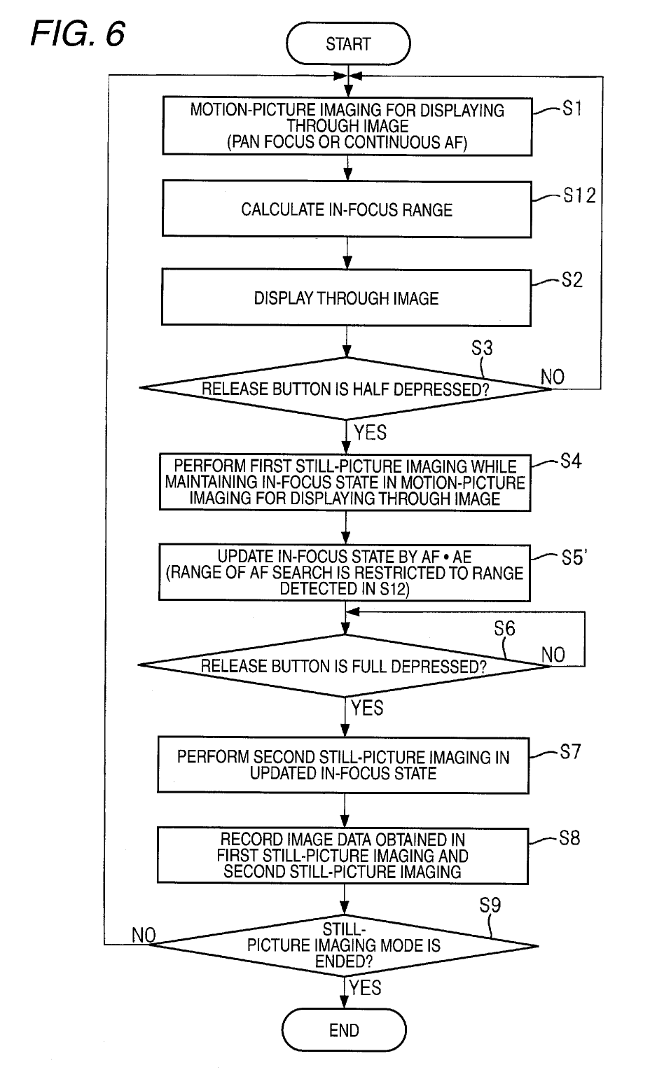

FIG. 6 is a view showing an operation flow in the still-picture imaging mode of the digital camera of the third embodiment. In FIG. 6, the same processes as those of FIG. 2 are denoted by the same reference numerals, and their description is omitted.

When the motion-picture imaging is started in step S1, the in-focus range is calculated on the basis of the in-focus state which is set in the motion-picture imaging (step S12). After step S12, steps S2 to S4 are performed.

After step S4, the system controlling section 11 executes the AF function to move the focus lens to the focusing position and update the in-focus state to that for still-picture imaging, and performs AE (Automatic Exposure) to set the imaging conditions (the aperture value, the exposure time, and the like) for still-picture imaging (step S5′). During the execution of the AF function, the system controlling section 11 restricts the range where the focusing position of the focus lens is searched, to that corresponding to the in-focus range calculated in step S12, so that the AF process is performed more rapidly than the case where the range where the focus lens is movable is set as the search range. After step S5′, the processes including and subsequent to step S6 are performed.

As described above, according to the digital camera of the embodiment, since the AF process for the second still-picture imaging can be hastened, the time period from the first instruction to the completion of the updation of the in-focus state can be shortened, and the performance interval between the first still-picture imaging and the second still-picture imaging can be shortened. Therefore, it is possible to prevent the image contents of the first still-picture imaging and those of the second still-picture imaging from being largely different from each other, a photo opportunity can be ensured, and a high quality image which the user wants can be stored.

The search range of the focusing position which is set in step S5′ is not limited to the example in which the range is restricted to the in-focus range calculated in step S12, and may be any range as far as it is narrower than the range where the focus lens is movable. The degree of narrowing of the search range may be determined in accordance with the in-focus range calculated in step S12, and preferably set so as to include at least the in-focus range calculated in step S12.

### Fourth Embodiment

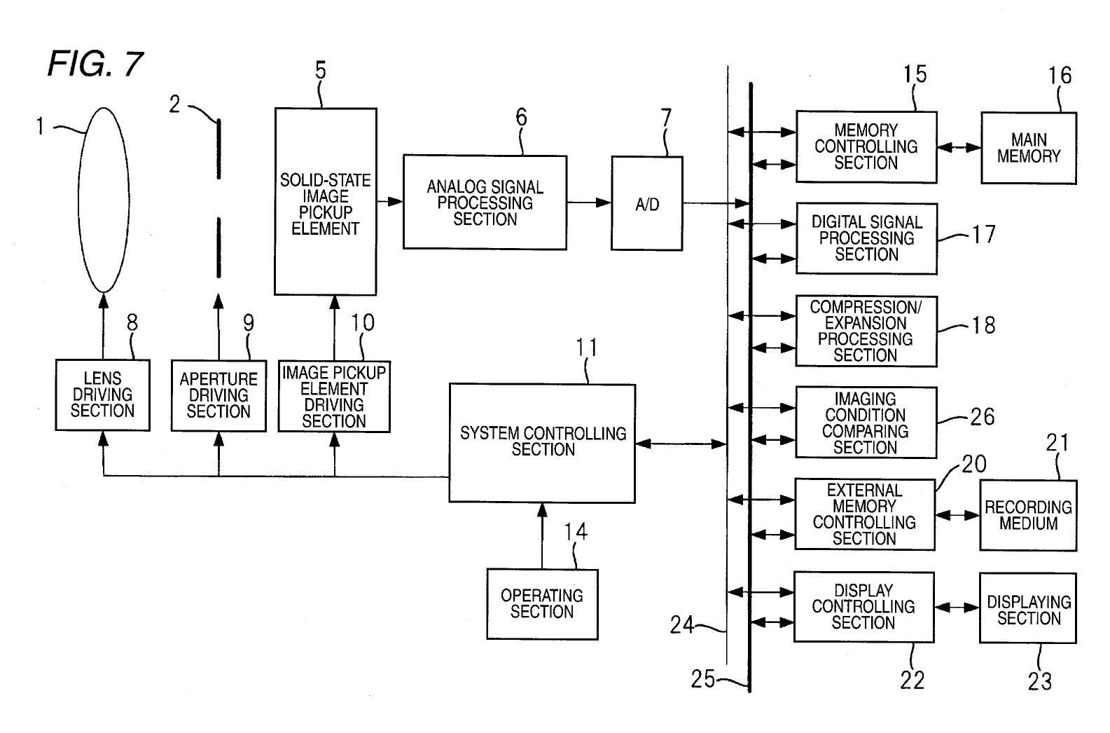

FIG. 7 is a diagram schematically showing the configuration of a digital camera of a fourth embodiment. In FIG. 7, similar components as those of FIG. 1 are denoted by the same reference numerals.

In the digital camera shown in FIG. 7, an imaging condition comparing section 26 is added to the digital camera shown in FIG. 1, and the function of the system controlling section 11 is partly changed.

The imaging condition comparing section 26 compares imaging conditions (including the exposure conditions such as the aperture value, the exposure time, and the like) which are settable in the case where the first still-picture imaging is to be performed, with each other, selects imaging conditions in which the time period required to elapse before the imaging is ended is shortest, and notifies the selected imaging conditions to the system controlling section 11.

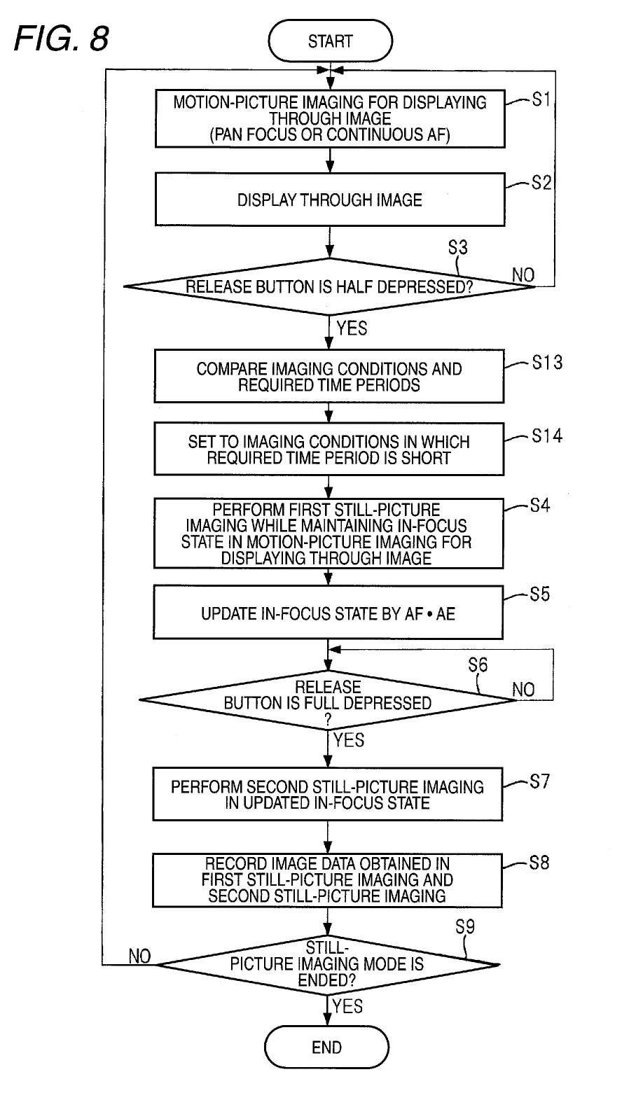

FIG. 8 is a view showing an operation flow in the still-picture imaging mode of the digital camera of the fourth embodiment. In FIG. 8, the same processes as those of FIG. 2 are denoted by the same reference numerals, and their description is omitted.

When the release button is half depressed in step S3, imaging conditions which are settable at this timing are compared to each other by the imaging condition comparing section 26 (step S13). Among the settable imaging conditions, imaging conditions in which the time period required to elapse before the imaging is ended is shortest (among imaging conditions which can realize exposure at the timing of step S3: YES, for example, imaging conditions having the shortest exposure time) are selected, and notified to the system controlling section 11. In the system controlling section 11, the notified imaging conditions are set as the imaging conditions in the first still-picture imaging (step S14). While maintaining the in-focus state at this timing, then, the first still-picture imaging is executed under the imaging conditions which are set in step S14 (step S4). After step S4, the processes including and subsequent to step S5 are executed.

In the case where the first still-picture imaging is performed in the pan focus mode, there is a case where, depending on the state of the aperture 2, the shutter speed must be lowered or the amplification gain of the imaging signal must be increased. When the first still-picture imaging is performed as described above in accordance with imaging conditions in which the required time period is shortest among settable imaging conditions, the time period from the timing when the release button is half depressed to that when full depression of the release button is enabled can be shortened. Therefore, the performance interval between the first still-picture imaging and the second still-picture imaging can be shortened, it is possible to prevent the image contents of the first still-picture imaging and those of the second still-picture imaging from being largely different from each other, and a high quality image which the user wants can be stored.

The contents described in the embodiment can be combined with those described in the first to third embodiments.

### Fifth Embodiment

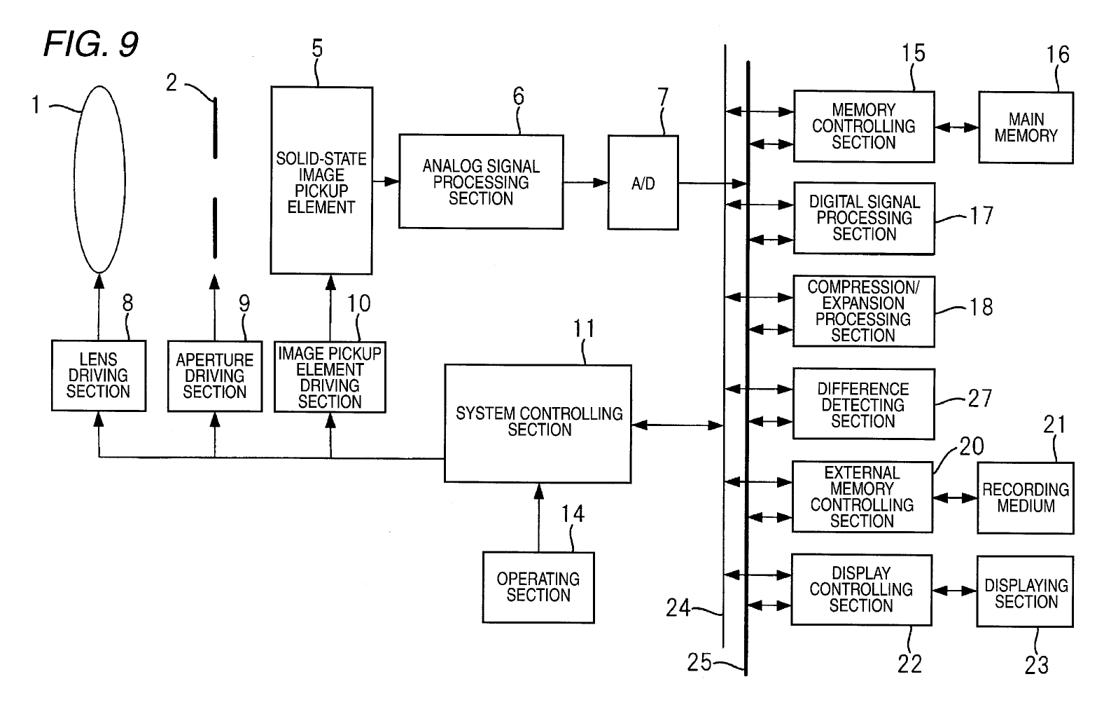

FIG. 9 is a diagram schematically showing the configuration of a digital camera of a fifth embodiment. In FIG. 9, similar components as those of FIG. 1 are denoted by the same reference numerals.

In the digital camera shown in FIG. 9, a difference detecting section 27 is added to the digital camera shown in FIG. 1, and the function of the system controlling section 11 is partly changed.

The difference detecting section 27 detects a difference between first image data obtained by the first still-picture imaging and second image data obtained by the second still-picture imaging, and notifies a result of the detection to the system controlling section 11. The difference detection can be realized by a method of comparing two sets of image data with each other, and detecting a case where the position of a unique portion (for example, a face portion of a human object) is different in images, or a case where the contrast of a unique portion is different.

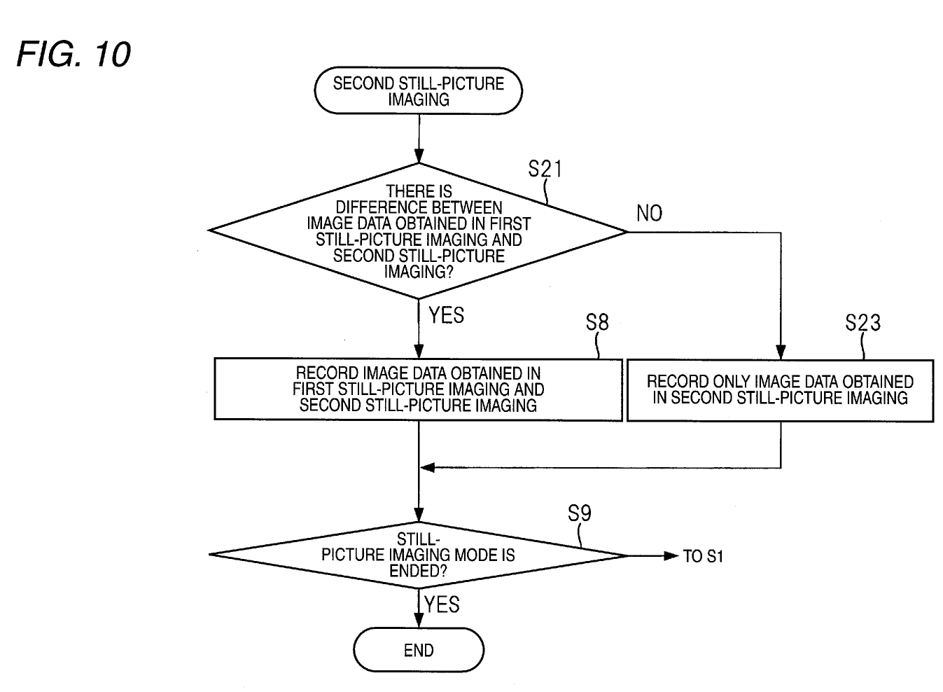

FIG. 10 is a view showing an operation flow in the still-picture imaging mode of the digital camera of the fifth embodiment. In FIG. 10, only processes subsequent to the second still-picture imaging of step S7 shown in FIG. 2 are illustrated. In FIG. 10, the same processes as those of FIG. 2 are denoted by the same reference numerals, and their description is omitted.

When the second still-picture imaging is performed in step S7 to produce the second image data, and the second image data are temporarily stored into the main memory 16, it is detected whether there is a difference between the first and second image data or not.

If there is a difference (step S21: YES), the processes including and subsequent to step S8 are performed. If there is not a difference (step S21: NO), the system controlling section 11 deletes the first data from the main memory 16 in accordance with the notification from the difference detecting section 27, records the second image data on the recording medium 21 (step S23), and transfers the process to step S9.

In the digital camera of the first embodiment, in the case where the first still-picture imaging and the second still-picture imaging are performed in the same in-focus state, when the position of the digital camera is not changed or when the object is not moved, for example, two sets of substantially same image data are recorded on the recording medium 21. According to the digital camera of the embodiment, when there is not a difference between the image data sets, only the second image data are recorded, and hence two sets of substantially same image data can be prevented from being recorded on the recording medium 21. Therefore, the capacity of the recording medium 21 can be saved, and, after imaging, the image data can be smoothly organized.

The contents described in the embodiment can be combined with those described in the third and fourth embodiments.

### Sixth Embodiment

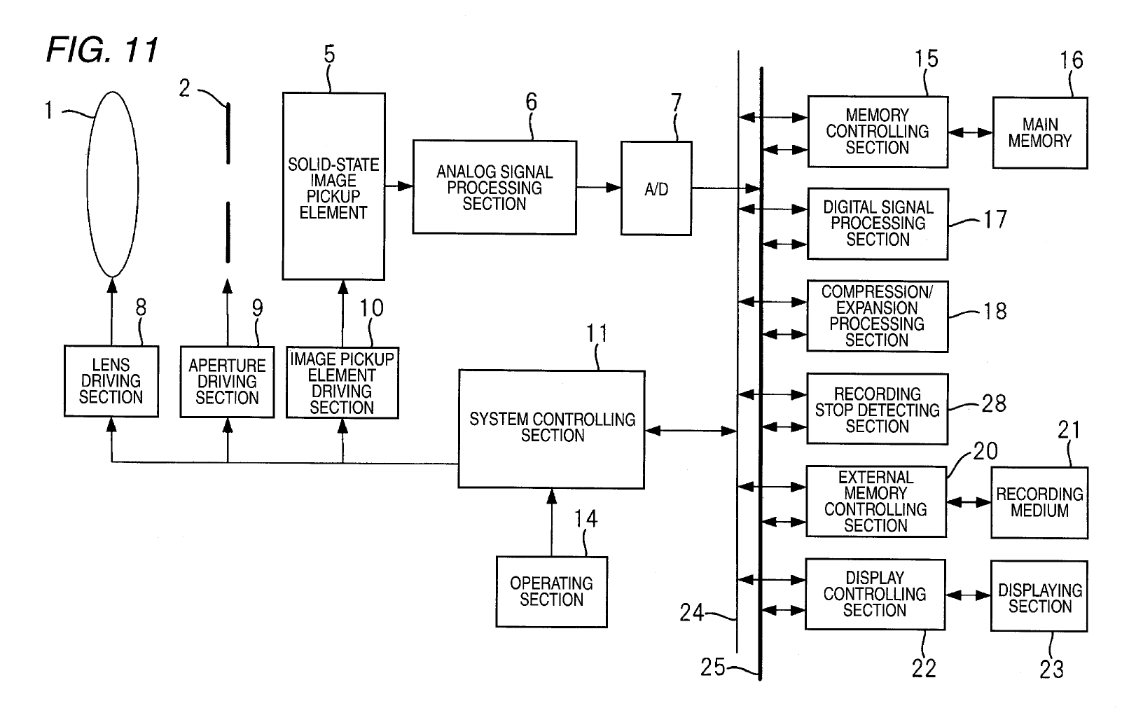

FIG. 11 is a diagram schematically showing the configuration of a digital camera of a sixth embodiment. In FIG. 11, similar components as those of FIG. 1 are denoted by the same reference numerals.

In the digital camera shown in FIG. 11, a recording stop detecting section 28 is added to the digital camera shown in FIG. 1, and the function of the system controlling section 11 is partly changed.

In one of cases where the second instruction is not given within a predetermined time period after the first instruction is given, and where the digital camera is moved by a predetermined amount or more after the first instruction is given, the recording stop detecting section 28 determines that the timing when the first still-picture imaging is performed is not a timing when the user intends to perform an imaging operation, and issues instructions for stopping the recording of the first image data, to the system controlling section 11. The recording stop detecting section 28 determines whether one of the above cases occurs or not, by measuring the time period from the half depression of the release button to the full depression with a timer, and detecting motion of the digital camera with using a sensor which detects the angular velocity, the acceleration, the inclination, and the like.

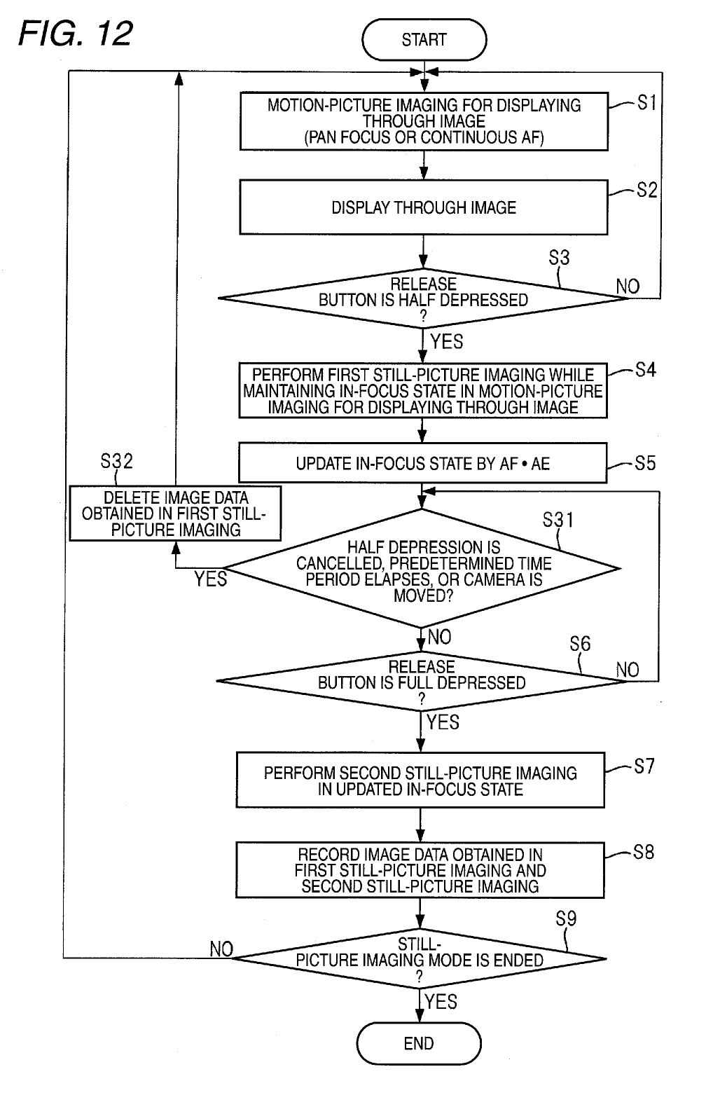

FIG. 12 is a view showing an operation flow in the still-picture imaging mode of the digital camera of the sixth embodiment. In FIG. 12, the same processes as those of FIG. 2 are denoted by the same reference numerals, and their description is omitted.

After step S5, in one of the cases where half depression of the release button is cancelled and the first instruction is cancelled, where full depression is not performed within a predetermined time period after the release button is half depressed, and where the digital camera is moved by a predetermined amount or more after the release button is half depressed (step S31: YES), the system controlling section 11 deletes the first image data from the main memory 16 (step S32), and transfers the process to step S1.

By contrast, if there is none of the cases where half depression of the release button is cancelled and the first instruction is cancelled, where full depression is not performed within a predetermined time period after the release button is half depressed, and where the digital camera is moved by a predetermined amount or more after the release button is half depressed (step S31: NO), the processes including and subsequent to step S6 are performed.

As described above, according to the digital camera of the embodiment, it is possible to prevent image data which are not intended by user, from being recorded on the recording medium 21. Therefore, the capacity of the recording medium 21 can be saved. A cumbersome operation of deleting image data which the user does not intend to image is not required to be performed by the user. Therefore, the ease of use is improved.

Alternatively, after step S31: YES, the user may be asked whether the first image data are to be deleted or not. If instructions for deleting are given, the first image data may be deleted. In the alternative, if instructions for not deleting are given, the first image data may be recorded on the recording medium 21, and then the process may be transferred to step S1.

The contents described in the embodiment can be combined with those described in the second to fifth embodiments.

### Seventh Embodiment

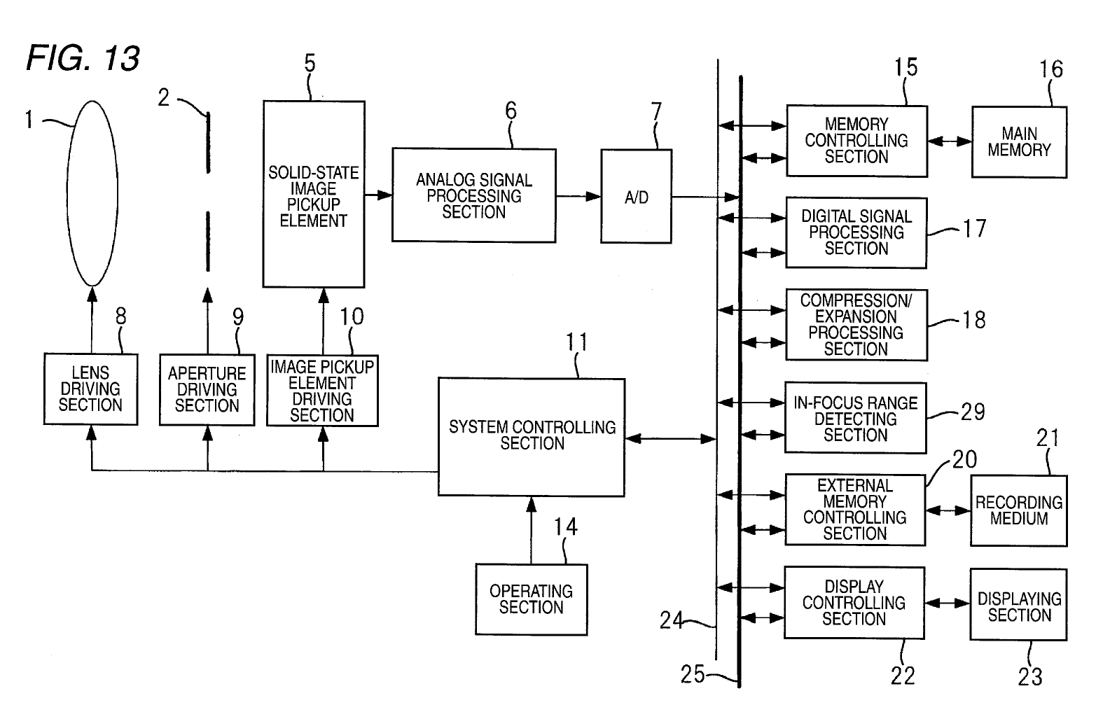

FIG. 13 is a diagram schematically showing the configuration of a digital camera of a seventh embodiment.

In the digital camera shown in FIG. 13, an in-focus range detecting section 29 is added to the digital camera shown in FIG. 1, and the function of the system controlling section 11 is partly changed.

From each of the first and second image data, the in-focus range detecting section 29 detects a range where in-focus is attained in the image data, by contrast detection or the like, and notifies the detected range to the system controlling section 11.

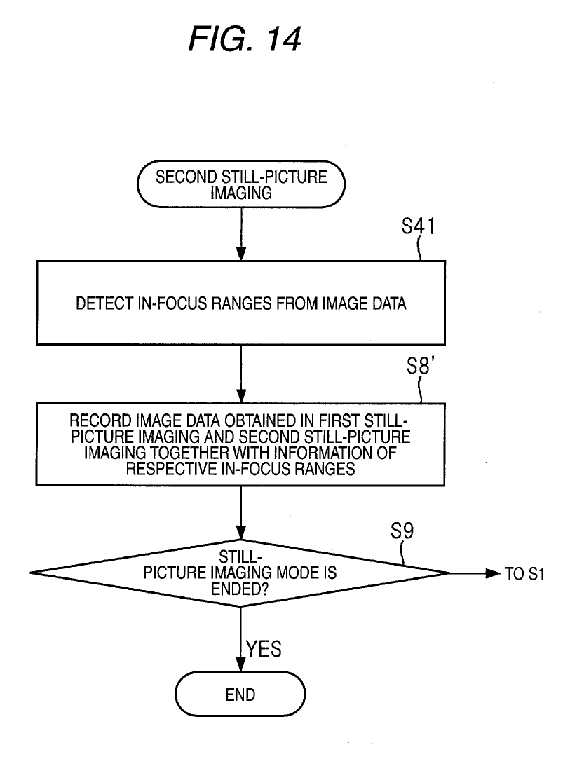

FIG. 14 is a view showing an operation flow in the still-picture imaging mode of the digital camera of the seventh embodiment. In FIG. 14, only processes subsequent to the second still-picture imaging of step S7 shown in FIG. 2 are illustrated. In FIG. 14, the same process as that of FIG. 2 is denoted by the same reference numeral, and its description is omitted.

When the second still-picture imaging is performed in step S7 to produce the second image data, and the second image data are temporarily stored into the main memory 16, a range where in-focus is attained is detected from each of the first and second image data (step S41).

Next, the system controlling section 11 records the first image data in correspondence with information of the in-focus range detected from the image data, on the recording medium 21, and the second image data in correspondence with information of the in-focus range detected from the image data, on the recording medium 21 (step S8′). In order to identify that the first and second image data are obtained as a result of the half depression of the release button and the subsequent full depression, the system controlling section 11 records the first and second image data in correspondence with each other. After step S8′, the process is transferred to step S9.

When instructions for reproducing the first image data recorded on the recording medium 21 are issued, the system controlling section 11 reads out the first image data, the second image data corresponding to the first image data, and the information of the in-focus states corresponding respectively to the first and second image data, from the recording medium 21, and displays a first image based on the first image data, and a second image based on the second image data on the displaying section 23. In the first and second images, the in-focus ranges respectively corresponding to the image data are superimposedly displayed by hatching, coloring, or the like.

As described above, according to the digital camera of the embodiment, also information of the in-focus ranges is recorded correspondingly with the first and second image data, and hence information of the in-focus ranges corresponded with the first and second image data can be checked during reproduction. Therefore, it is possible to determine which image data are obtained in the intended in-focus state, and therefore the image data can be easily selected.

The in-focus range of the second image data, and a portion of the first image data corresponding to the range may be enlargedly displayed at the same magnification.

The contents described in the embodiment can be combined with those described in the second to sixth embodiments.

The function of the digital camera which has been described may be always executed in the still-picture imaging mode, or may be executed only when the digital camera is set to a specific mode (for example, the continuous imaging mode).

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An imaging apparatus comprising a movable focus lens, wherein
said apparatus comprises an imaging unit which, when a first instruction for starting setting of an in-focus state for still-picture imaging is given during motion-picture imaging for displaying a through image, performs first still-picture imaging while maintaining an in-focus state in the motion-picture imaging for displaying a through image.

2. The imaging apparatus according to claim 1, wherein
said apparatus further comprises an in-focus state setting unit which, after the first still-picture imaging is ended, starts the setting of the in-focus state for still-picture imaging, and,
when a second instruction for performing still-picture imaging is given after the first instruction, said imaging unit performs second still-picture imaging in the in-focus state which is set by said in-focus state setting unit.

3. The imaging apparatus according to claim 2, wherein
said in-focus state setting unit automatically performs the setting of the in-focus state for still-picture imaging in accordance with an object, and makes a search range of a position of said focus lens in the in-focus state to be narrower than a movable range of said focus lens in accordance with an in-focus range based on the in-focus state in the motion-picture imaging for displaying a through image.

4. The imaging apparatus according to claim 2, wherein
said apparatus further comprises a motion detecting unit which detects motion of said apparatus, and,
when said motion detecting unit detects motion between said apparatus at a timing when the first still-picture imaging is performed, and said apparatus at a timing when the second instruction is given, said apparatus performs the second still-picture imaging after the motion is offset by relatively moving an optical system of said apparatus and a solid-state image pickup element so that a same object image is taken by the first still-picture imaging and the second still-picture imaging.

5. The imaging apparatus according to claim 2, wherein
said apparatus further comprises:
a difference detecting unit which detects a difference between first image data obtained by the first still-picture imaging and second image data obtained by the second still-picture imaging; and
a recording unit which, when there is a difference between the first image data and the second image data, records the first image data and the second image data on a recording medium which can output data to an external, and which, when there is not the difference, records only the second image data on the recording medium.

6. The imaging apparatus according to claim 2, wherein
said apparatus further comprises:
an in-focus range detecting unit which detects an in-focus range for each of first image data obtained by the first still-picture imaging and second image data obtained by the second still-picture imaging; and
a recording unit which records sets of information of the in-focus ranges detected by said in-focus range detecting unit, in correspondence with the first image data and the second image data.

7. The imaging apparatus according to claim 6, wherein
said apparatus further comprises a display controlling unit which controls a displaying unit to display an image based on the image data recorded by said recording unit, and,
when images based on the first image data and the second image data are to be displayed, said display controlling unit controls said displaying unit to display also the sets of information of the in-focus ranges which are recorded respectively in correspondence with the first image data and the second image data.

8. The imaging apparatus according to claim 2, wherein
said apparatus further comprises a recording unit which records image data obtained by the first still-picture imaging, on a recording medium, and
said recording unit deletes the image data obtained by the first still-picture imaging, in one of cases where the first instruction is cancelled after the first still-picture imaging is ended, where the second instruction is not given within a predetermined time period after the first instruction is given, and where said apparatus is moved by a predetermined amount or more after the first instruction is given.

9. The imaging apparatus according to claim 2, wherein
said imaging unit performs the first still-picture imaging in accordance with imaging conditions in which a time period required to elapse before the imaging is ended is shortest among imaging conditions that can be set in imaging in the in-focus state in the motion-picture imaging for displaying a through image.

10. An imaging method which is performed by an imaging apparatus comprising a movable focus lens, wherein
said method comprises an imaging step of, when a first instruction for starting setting of an in-focus state for still-picture imaging is given during motion-picture imaging for displaying a through image, performing first still-picture imaging while maintaining an in-focus state in the motion-picture imaging for displaying a through image.

11. The imaging method according to claim 10, wherein
said method further comprises an in-focus state setting step of, after the first still-picture imaging is ended, starting the setting of the in-focus state for still-picture imaging, and,
in said imaging step, when a second instruction for performing still-picture imaging is given after the first instruction, performing second still-picture imaging in the in-focus state which is set in said in-focus state setting step.

12. The imaging method according to claim 11, wherein,
in said in-focus state setting step, the setting of the in-focus state for still-picture imaging is automatically performed in accordance with an object, and a search range of a position of said focus lens in the in-focus state is made narrower than a movable range of said focus lens in accordance with an in-focus range based on the in-focus state in the motion-picture imaging for displaying a through image.

13. The imaging method according to claim 11, wherein
said method further comprises a motion detecting step of detecting motion of said apparatus, and,
in said imaging step, when motion between said apparatus at a timing when the first still-picture imaging is performed, and said apparatus at a timing when the second instruction is given is detected in said motion detecting step, the second still-picture imaging is performed after the motion is offset by relatively moving an optical system of said apparatus and a solid-state image pickup element so that a same object image is taken by the first still-picture imaging and the second still-picture imaging.

14. The imaging method according to claim 11, wherein
said method further comprises:
a difference detecting step of detecting a difference between first image data obtained by the first still-picture imaging and second image data obtained by the second still-picture imaging; and
a recording step of, when there is a difference between the first image data and the second image data, recording the first image data and the second image data on a recording medium which can output data to an external, and, when there is not the difference, recording only the second image data on the recording medium.

15. The imaging method according to claim 11, wherein
said method further comprises:
an in-focus range detecting step of detecting an in-focus range for each of first image data obtained by the first still-picture imaging and second image data obtained by the second still-picture imaging; and
a recording step of recording sets of information of the in-focus ranges detected in said in-focus range detecting step, in correspondence with the first image data and the second image data.

16. The imaging method according to claim 15, wherein
said method further comprises a display controlling step of controlling a displaying unit to display an image based on the image data recorded in said recording step, and,
when images based on the first image data and the second image data are to be displayed, said display controlling step controls to display also the sets of information of the in-focus ranges which are recorded respectively in correspondence with the first image data and the second image data.

17. The imaging method according to claim 11, wherein
said method further comprises a recording step of recording image data obtained by the first still-picture imaging, on a recording medium, and
the image data obtained by the first still-picture imaging are deleted in said recording step, in one of cases where the first instruction is cancelled after the first still-picture imaging is ended, where the second instruction is not given within a predetermined time period after the first instruction is given, and where said apparatus is moved by a predetermined amount or more after the first instruction is given.

18. The imaging method according to claim 11, wherein,
in said imaging step, the first still-picture imaging is performed in accordance with imaging conditions in which a time period required to elapse before the imaging is ended is shortest among imaging conditions that can be set in imaging in the in-focus state in the motion-picture imaging for displaying a through image.
